(19) United States
(12) Patent Application Publication
(10) Pub. No.: US 2022/0108661 A1
(43) Pub. Date: Apr. 7, 2022

(54) ELECTROPHORETIC MEDIUM INCLUDING FLUORESCENT PARTICLES

(71) Applicant: E Ink California, LLC, Fremont, CA (US)

(72) Inventor: Xiaolong ZHENG, Fremont, CA (US)

(21) Appl. No.: 17/490,093

(22) Filed: Sep. 30, 2021

Related U.S. Application Data
(60) Provisional application No. 63/088,148, filed on Oct. 6, 2020.

(51) Int. Cl. G09G 3/34; G02F 1/167; G02F 1/1676; C09K 11/02

(52) U.S. Cl. CPC G09G 3/344; G02F 1/167; G02F 2001/1678; C09K 11/025; G02F 1/1676

(57) ABSTRACT

An electrophoretic medium is disclosed comprising fluorescent particles. The core of fluorescent particles is a fluorescent pigment and the florescent particles further comprise a polymeric layer and a steric stabilizer.

### RELATED APPLICATIONS

This application claims priority to U.S. Provisional Patent Application No. 63/088,148, filed on Oct. 6, 2020. The entire contents of any patent, published application, or other published work referenced herein is incorporated by reference.

### FIELD OF THE INVENTION

The present invention is directed to an electrophoretic medium including fluorescent particles. The electrophoretic medium of the present invention can be used in electro-optic devices and it provides optical states that exhibit bright color and stable images. In another aspect, the present invention is an electro-optic device comprising said electrophoretic medium. In yet another aspect, the present invention is directed to a method of manufacturing of said electrophoretic medium including fluorescent particles.

### BACKGROUND OF THE INVENTION

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The term “gray state” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display, and should be understood as normally including extreme optical states which are not strictly black and white, for example the aforementioned white and dark blue states. The term “monochrome” may be used hereinafter to denote a drive scheme, which only drives pixels to their two extreme optical states with no intervening gray states.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

Several types of electro-optic displays are known. One type of electro-optic display is a rotating bichromal member type as described, for example, in U.S. Pat. Nos. 5,808,783; 5,777,782; 5,760,761; 6,054,071 6,055,091; 6,097,531; 6,128,124; 6,137,467; and 6,147,791 (although this type of display is often referred to as a “rotating bichromal ball” display, the term “rotating bichromal member” is preferred as more accurate since in some of the patents mentioned above the rotating members are not spherical). Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

Another type of electro-optic display uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. Nos. 6,301,038; 6,870,657; and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

Numerous patents and applications assigned to or in the names of the Massachusetts Institute of Technology (MIT), E Ink Corporation, E Ink California, LLC. and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 6,922,276 and 7,411,719;
(c) Microcell structures, wall materials, and methods of forming microcells; see for example U.S. Pat. Nos. 7,072,095 and 9,279,906;
(d) Methods for filling and sealing microcells; see for example U.S. Pat. Nos. 7,144,942 and 7,715,088;
(e) Films and sub-assemblies containing electro-optic materials; see for example U.S. Pat. Nos. 6,982,178 and 7,839,564;
(f) Backplanes, adhesive layers and other auxiliary layers and methods used in displays; see for example U.S. Pat. Nos. 7,116,318 and 7,535,624;
(g) Color formation and color adjustment; see for example U.S. Pat. Nos. 7,075,502 and 7,839,564;
(h) Methods for driving displays; see for example U.S. Pat. Nos. 7,012,600 and 7,453,445;
(i) Applications of displays; see for example U.S. Pat. Nos. 7,312,784 and 8,009,348; and
(j) Non-electrophoretic displays, as described in U.S. Pat. Nos. 6,241,921 and 2015/0277160; and applications of encapsulation and microcell technology other than displays; see for example U.S. Pat. No. 7,615,325; and U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be made inexpensively.

Other types of electro-optic media may also be used in the displays of the present invention.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

The manufacture of a three-layer electrophoretic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as one electrode of the final display) on a plastic film, the capsules/binder coating being dried to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. (A very similar process can be used to prepare an electrophoretic display usable with a stylus or similar movable electrode by replacing the backplane with a simple protective layer, such as a plastic film, over which the stylus or other movable electrode can slide.) In one preferred form of such a process, the backplane is itself flexible and is prepared by printing the pixel electrodes and conductors on a plastic film or other flexible substrate. The obvious lamination technique for mass production of displays by this process is roll lamination using a lamination adhesive.

As discussed in the aforementioned U.S. Pat. No. 6,982,178, (see column 3, line 63 to column 5, line 46) many of the components used in electrophoretic displays, and the methods used to manufacture such displays, are derived from technology used in liquid crystal displays (LCD's). For example, electrophoretic displays may make use of an active matrix backplane comprising an array of transistors or diodes and a corresponding array of pixel electrodes, and a “continuous” front electrode (in the sense of an electrode which extends over multiple pixels and typically the whole display) on a transparent substrate, these components being essentially the same as in LCD's. However, the methods used for assembling LCD's cannot be used with encapsulated electrophoretic displays. LCD's are normally assembled by forming the backplane and front electrode on separate glass substrates, then adhesively securing these components together leaving a small aperture between them, placing the resultant assembly under vacuum, and immersing the assembly in a bath of the liquid crystal, so that the liquid crystal flows through the aperture between the backplane and the front electrode. Finally, with the liquid crystal in place, the aperture is sealed to provide the final display.

This LCD assembly process cannot readily be transferred to encapsulated displays. Because the electrophoretic material is solid, it must be present between the backplane and the front electrode before these two integers are secured to each other. Furthermore, in contrast to a liquid crystal material, which is simply placed between the front electrode and the backplane without being attached to either, an encapsulated electrophoretic medium normally needs to be secured to both; in most cases the electrophoretic medium is formed on the front electrode, since this is generally easier than forming the medium on the circuitry-containing backplane, and the front electrode/electrophoretic medium combination is then laminated to the backplane, typically by covering the entire surface of the electrophoretic medium with an adhesive and laminating under heat, pressure and possibly vacuum. Accordingly, most prior art methods for final lamination of solid electrophoretic displays are essentially batch methods in which, typically, the electro-optic medium, a lamination adhesive and a backplane are brought together immediately prior to final assembly, and it is desirable to provide methods better adapted for mass production.

Electro-optic displays are often costly; for example, the cost of the color LCD found in a portable computer is typically a substantial fraction of the entire cost of the computer. As the use of electro-optic displays spreads to devices, such as cellular telephones and personal digital assistants (PDA's), much less costly than portable computers, there is great pressure to reduce the costs of such displays. The ability to form layers of some solid electro-optic media by printing techniques on flexible substrates, as discussed above, opens up the possibility of reducing the cost of electro-optic components of displays by using mass production techniques such as roll-to-roll coating using commercial equipment used for the production of coated papers, polymeric films and similar media.

The aforementioned U.S. Pat. No. 6,982,178 describes a method of assembling a solid electro-optic display (including an encapsulated electrophoretic display) which is well adapted for mass production. Essentially, this patent describes a so-called “front plane laminate” (“FPL”) which comprises, in order, a light-transmissive electrically-conductive layer; a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term “light-transmissive” should of course be interpreted to refer to transmission of the relevant non-visible wavelengths. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly(ethylene terephthalate) (PET) films coated with aluminum or ITO are available commercially, for example as “aluminized Mylar” (“Mylar” is a Registered Trade Mark) from E.I. du Pont de Nemours & Company, Wilmington Del., and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically-conductive layer to the backplane. This process is well-adapted to mass production since the front plane laminate may be mass produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate already described, but involving two separate laminations; typically, in a first lamination the double release sheet is laminated to a front electrode to form a front sub-assembly, and then in a second lamination the front sub-assembly is laminated to a backplane to form the final display, although the order of these two laminations could be reversed if desired.

U.S. Pat. No. 7,839,564 describes a so-called “inverted front plane laminate”, which is a variant of the front plane laminate described in the aforementioned U.S. Pat. No. 6,982,178. This inverted front plane laminate comprises, in order, at least one of a light-transmissive protective layer and a light-transmissive electrically-conductive layer; an adhesive layer; a layer of a solid electro-optic medium; and a release sheet. This inverted front plane laminate is used to form an electro-optic display having a layer of lamination adhesive between the electro-optic layer and the front electrode or front substrate; a second, typically thin layer of adhesive may or may not be present between the electro-optic layer and a backplane. Such electro-optic displays can combine good resolution with good low temperature performance.

Currently, electrophoretic media of electrophoretic displays comprise traditional organic and/or inorganic pigment particles. In the absence of a display built-in front light, the brightness of the reflected image and the vibrancy of the display colors of such reflective displays depend on the ambient light. Thus, there is a need for improved image brightness and color vibrancy. Furthermore, there is a need for image stability, which may become inferior when the electrophoretic particles become flocculated or aggregated. The inventor of the present invention surprisingly found that the use of electrophoretic media having fluorescent particles, the fluorescent particles comprising a core having a fluorescent pigment and a shell comprising a polymeric layer and a steric stabilizer, improves the electro-optic performance of electro-optic devices.

### SUMMARY OF THE INVENTION

The present invention is directed to an electrophoretic medium comprising fluorescent particles dispersed in a fluid. The present invention is also directed to an electro-optic device comprising electrophoretic medium having fluorescent particles dispersed in a non-polar fluid. The present invention is also directed to a method of manufacturing an electrophoretic medium comprising an electrophoretic medium comprising fluorescent particles dispersed in a non-polar fluid.

In one aspect, the electrophoretic medium of the present invention comprises a first type of fluorescent particles dispersed in a non-polar fluid. The first type of fluorescent particles comprises a core and a shell. The core comprises a first type of fluorescent pigment, and the shell comprises a polymeric layer, and a steric stabilizer. The first type of fluorescent pigment may comprise a fluorescent dye in a polymer matrix. The first type of fluorescent particles may be charged, having a first charge polarity. The charge of the first type of fluorescent particles may be the result of charge or chargeable functional groups of the first type of fluorescent pigment or the charge or chargeable functional groups of the polymeric layer or charge or chargeable functional groups of the steric stabilizer. The polymeric layer may be adsorbed, complexed, or covalently bonded onto the surface of the first type of fluorescent particles. The steric stabilizer of the shell may be adsorbed, complexed, or covalently bonded onto the polymeric layer of the shell. The polymeric layer of the shell of the first type of fluorescent particles may be formed from polymerization of a first monomer or oligomer, the first monomer or oligomer being selected from the group consisting of acrylate, methacrylate, styrene, methylstyrene, siloxane, ethylene, propylene, and mixtures thereof. The steric stabilizer of the shell of the first type of fluorescent particles may be formed from polymerization of a second monomer or oligomer, the second monomer or oligomer being selected from the group consisting of acrylate, methacrylate, styrene, methylstyrene, siloxane, ethylene, propylene, and mixtures thereof.

The electrophoretic medium may further comprise a second type of fluorescent particles comprising a core and a shell, the core comprising a second type of fluorescent pigment, and the shell comprising a polymeric layer and a steric stabilizer, the second type of fluorescent particles having a second color, the second color being different from the first color, and the second charge polarity being opposite from the first charge polarity. The electrophoretic medium may further comprise a third type of charged particles comprising a third type of organic pigment, wherein the third type of organic pigment has a third color and a second charge polarity, the third color being different from the first and the second colors, and the second charge polarity being different from the first charge polarity. The electrophoretic medium may further comprise a fourth type of charged particles comprising a fourth type of inorganic pigment, wherein the fourth type of inorganic pigment has a fourth color and a second charge polarity, the fourth color being different from the first, second and third colors, and the second charge polarity being different from the first charge polarity. The core of the first type of fluorescent particles may further comprise a fifth type of pigment selected from the group consisting of a fluorescent pigment, an organic pigment, an inorganic pigment, and a mixture thereof The color of the fifth type of pigment may be white, black, orange, red, magenta, yellow, cyan, blue, violet, green, or another color.

The non-polar fluid of the electrophoretic medium may be colorless or it may be colored with a dye. The dye is soluble in the non-polar fluid. The non-polar fluid may be a hydrocarbon.

In one aspect, the present invention is directed to an electro-optic device. The electro-optic device may be an electrophoretic display. The electro-optic device comprises a first light-transmissive electrode layer, an electrophoretic medium layer, and a second electrode layer, the electrophoretic medium layer being located between the first light-transmissive layer and the second electrode layer. The electrophoretic medium layer comprises electrophoretic medium. The electrophoretic medium comprises a first type of fluorescent particles dispersed in a non-polar fluid. The first type of fluorescent particles comprises a core and a shell, the core comprising a first type of fluorescent pigment, and the shell comprising a polymeric layer and a steric stabilizer. The first type of fluorescent particles has a first color. The first type of fluorescent pigment may comprise a fluorescent dye in a polymer matrix. The first type of fluorescent particles may be charged, having a first charge polarity. The charge of the first type of fluorescent particles may be the result of charge or chargeable functional groups of the first type of fluorescent pigment or the charge or chargeable functional groups of the polymeric layer or charge or chargeable functional groups of the steric stabilizer. The shell may be adsorbed, complexed, or covalently bonded onto the surface of the first type of fluorescent particles. The steric stabilizer of the shell may be adsorbed, complexed, or covalently bonded onto the polymeric layer of the shell.

In another aspect, the present invention is directed to a method of manufacturing an electrophoretic medium comprising the steps (1) providing a dispersion of a first type of fluorescent pigment in a carrier; (2) forming a first type of fluorescent particles by the addition of a first type of monomer or oligomer and a second type of monomer or oligomer into the dispersion of the first type of fluorescent pigment in the carrier, and by polymerization of the first monomer or oligomer and the second monomer or oligomer under agitation. The first type of fluorescent particles comprising a core and a shell. The core comprises the first type of fluorescent pigment, and the shell comprises a polymeric layer formed by the polymerization of the first monomer or oligomer, and a steric stabilizer formed by the polymerization of the second polymer or oligomer. The method of manufacturing an electrophoretic medium may further comprise the steps of (3) isolating the first type of fluorescent particles; and (4) redispersing the isolated first type of fluorescent particles into a non-polar fluid. The first type of fluorescent pigment may comprise a fluorescent dye in a polymer matrix.

### BRIEF DESCRIPTION OF THE DRAWINGS

FIG. 1 illustrates an example of a fluorescent particle of the present invention.

FIGS. 2A, 2B, and 2C shows three different optical states of an electro-optic device of the present invention. The electro-optic device comprises an electrophoretic medium having a first type of fluorescent particles and a fourth type of charged particles. The two different types of particles in this example are oppositely charged. The electrophoretic medium is encapsulated in microcells.

FIG. 3 shows an optical state of an electro-optic device of the present invention comprising an electrophoretic medium having a first type of fluorescent particles and a third type (or fourth type) of charged particles. The two different types of particles in this example are oppositely charged. The electrophoretic medium is encapsulated in microcapsules.

FIG. 4 shows color measurements of the white state and the orange state of the electrophoretic device of Example 2. The orange state appears darker in FIG. 4.

FIG. 5 is a graph that corresponds to the thermogravimetric analysis (TGA) of a first type of fluorescent pigment before its surface treatment with a polymeric material.

FIG. 6 is a graph that corresponds to the thermogravimetric analysis (TGA) of the first type of fluorescent particles from Example 1, wherein the core is fluorescent pigment Blaze Orange™ AX-15-N (supplied by DayGlo).

FIG. 7 is an illustration of a method of making of first type of fluorescent particles via living polymerization.

### DETAILED DESCRIPTION OF THE INVENTION

The term “charged particles” as used herein means electrically charged particles.

An electrophoretic display (EPD) is a non-emissive device based on the electrophoresis phenomenon influencing charged pigment particles dispersed in a non-polar fluid. An EPD typically comprises an electrophoretic medium layer. The electrophoretic medium layer comprises an electrophoretic medium that comprises charged particles in the non-polar fluid. The electrophoretic medium layer is disposed between a pair of spaced-apart electrodes. At least one of the electrodes, located on the viewing side of the device, is light-transmissive. Typically, the other electrode comprises a set of pixel electrodes.

The non-polar fluid may be a hydrocarbon solvent or a combination of hydrocarbon solvents. In one example of electrophoretic display, the electrophoretic medium comprises one type of charged particles having one color in a non-polar fluid having a contrasting color. In this case, when a voltage difference is imposed between the two electrodes, the pigment particles migrate by attraction to the electrode of polarity opposite that of the pigment particles. Thus, the color showing at the transparent plate may be either the color of the solvent or the color of the pigment particles. Reversal of plate polarity will cause the particles to migrate back to the opposite plate, thereby reversing the color.

Alternatively, an electrophoretic medium may have two types of pigment particles of contrasting colors and carrying opposite charges. The two types of pigment particles are dispersed in a clear fluid. In this case, when a voltage difference is imposed between the two electrodes, the two types of pigment particles would move towards the opposite ends (top or bottom) in a display cell. Thus, one of the colors of the two types of the pigment particles would be seen at the viewing side of the display cell.

In another alternative, an additional type of pigment particles are added to an electrophoretic medium for forming a highlight or multicolor display device.

In an ideal device, the charged pigment particles remain separate and do not agglomerate or flocculate (sticking to each other or to the electrodes), under all operating conditions.

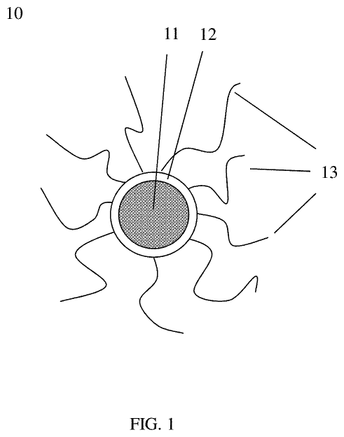

The present invention is directed to an electrophoretic medium comprising a first type of fluorescent particles dispersed in a non-polar fluid. The first type of fluorescent particle is illustrated in FIG. 1. The core of the first type fluorescent particle 10 of FIG. 1 comprises a first type of fluorescent pigment 11. The shell of the first type of fluorescent particles comprises a polymeric layer 12 and a steric stabilizer 13. The polymeric layer 12 of the shell of the first type of fluorescent particle comprises a polymeric material, which may be formed on the surface of the core by polymerization of a first type of monomer or oligomer. The polymeric layer 12 may also be formed from a reaction of a first type of macromonomer with the first type of fluorescent pigment, or from the adsorption or complexation of a first type of polymer onto the surface of the first type of fluorescent pigment. The steric stabilizer 13 of the shell of the first type of fluorescent particle may be formed on the surface of the polymeric layer 12 from polymerization of a second type of monomer, or oligomer. The steric stabilizer 13 may also be formed from a reaction of a second type of macromonomer with the polymeric layer second type of macromonomer with the polymeric layer 13, or from the adsorption or complexation of a second type of polymer onto the surface of the polymeric layer 12. The monomers, oligomer and macromonomer of the polymeric layer may comprise acrylate, methacrylate, styrene, siloxane, ethylene, propylene, or a mixture thereof. The steric stabilizer 13 of the first type of fluorescent particles enables the first type of fluorescent particles in the electrophoretic medium to be present in a non-flocculated and non-aggregated state. The polymeric layer 12 may comprise more than one polymers and may be formed by more than one monomers, oligomers or macromonomers. The steric stabilizer 13 may also comprise more than one polymers and may be formed by more than one monomers, oligomers or macromonomers. Typically, the material of the polymeric layer 12 is more polar than the material of the steric stabilizer 13. The polymeric layer 12 may be covalently bonded to the first type of fluorescent pigment 11 or it may be adsorbed or complexed on the surface of the first type of fluorescent pigment. The steric stabilizer 13 may be covalently bonded onto the polymeric layer 12. The steric stabilizer 13 and the polymeric layer 12 may comprise functional groups that enable charge generation or interaction with a charge control agent. The first type of fluorescent particles may comprise from 10 weight percent to 99 weight percent of the first type of fluorescent pigment by weight of the first type of fluorescent particle, or from 20 weight percent to 95 weight percent of the first type of fluorescent pigment by weight of the first type of fluorescent particle, or from 25 weight percent to 92 weight percent of the first type of fluorescent pigment by weight of the first type of fluorescent particle, or from 35 weight percent to 90 weight percent of the first type of fluorescent pigment by weight of the first type of fluorescent particle, or from 45 weight percent to 88 weight percent of the first type of fluorescent pigment by weight of the first type of fluorescent particle, or from 40 weight percent to 85 weight percent of the first type of fluorescent pigment by weight of the first type of fluorescent particle, or from 50 weight percent to 80 weight percent of the first type of fluorescent pigment by weight of the first type of fluorescent particle.

The first type of fluorescent particles may comprise from 0.5 weight percent to 95 weight percent of the first type of fluorescent pigment by weight of the first type of fluorescent particle, or from 1 weight percent to 85 weight percent of the first type of fluorescent pigment by weight of the first type of fluorescent particle, or from 2 weight percent to 70 weight percent of the first type of fluorescent pigment by weight of the first type of fluorescent particle, or from 5 weight percent to 50 weight percent of the first type of fluorescent pigment by weight of the first type of fluorescent particle, or from 8 weight percent to 40 weight percent of the first type of fluorescent pigment by weight of the first type of fluorescent particle, or from 10 weight percent to 30 weight percent of the first type of fluorescent pigment by weight of the first type of fluorescent particle.

The volume average diameter of the first type of fluorescent particles may be from 100 nm to 5 μm, or from 300 nm to 1.5 μm, or from 500 nm to 1 μm.

The core of the first type of fluorescent particles may comprise, in addition to the first type of fluorescent pigment, a fifth type of pigment. The fifth type of pigment may be selected from a group consisting of a fifth type of fluorescent pigment, a fifth type of organic pigment, a fifth type of inorganic pigment, and mixtures thereof. The color of the fifth type of pigment may be white, black, orange, red, magenta, yellow, cyan, blue, violet, green, or another color.

The first type of fluorescent particles has a first color. The first color may be orange, red, magenta, yellow, cyan, blue, violet, green, black, white or other color. The first type of fluorescent particle may have an electric charge of a first polarity. The charge of the first type of fluorescent particles may be the result of charge or chargeable functional groups of the first type of fluorescent pigment or the charge or chargeable functional groups of the polymeric layer or charge or chargeable functional groups of the steric stabilizer or a charge because of the interaction of the first type of fluorescent particles with a charge control agent, which may be present in the electrophoretic medium. The first charge polarity may be positive or negative.

Fluorescent pigments are solid materials that absorb light in a UV spectrum and emit light of longer wavelength. One class of fluorescent pigments are formed by the combination of fluorescent dyes and polymeric resins. These fluorescent pigments provide color that is much brighter and more vibrant than traditional pigments and they offer unique optical effects as they glow under UV and black light. The resins that are used for forming fluorescent pigments with fluorescent dyes include both thermoplastic and thermoset polymers. Non-limiting examples of such resins are polyamides, polyestrers, acrylic, styrene, melamine-formaldehyde, and benzoguanamine-formaldehyde, There are numerous commercial fluorescent pigment in the market based on a variety of fluorescent dyes and a variety of resins. Non-limiting examples of fluorescent pigment are Aurora Pink® A-11, Rocket Red™ A-13-N, Fire Orange™ A-14-N, Blaze Orange™ A-15-N, Signal Green™ A-17-N, Horizon Blue™ A-19, Corona Magenta™ A-21, Aurora Pink® AX-11-5, Neon Red™ AX-12-5, Rocket Red™ AX-13-5, Fire Orange™ AX-14-N, Blaze Orange™ AX-15-N, Arc Yellow™ AX-16, N Saturn Yellow® AX-17-N, Signal Green™ AX-18-N, Horizon Blue™ A-19, Corona Magenta™ AX-21, Aurora Pink® ECO-11, Rocket Red™ ECO-13, Fire Orange™ ECO-14, Blaze Orange™ ECO-15, Saturn Yellow™ ECO-17, Signal Green™ ECO-18, Horizon Blue™ ECO-19, Ultra Violet™ ECO-20, Corona Magenta™ ECO-21, EZ-11 Aurora Pink®, EZ-15 Blaze Orange™, EZ-17 Saturn Yellow®, EZ-18 Signal Green™, EZ-21 Corona Magenta™, GC17F Citrine Yellow, GC18XPF Emerald Green MB, GC19XPF Sapphire Blue MB, GC26F Crimson Red, GPF22 Corona Magenta™, GPF26 Rocket Red™, GPF30 Blaze Orange™, GPF31 Aurora Pink®, GPF34 Saturn Yellow®, GPL-11 Aurora Pink®, GPL-13 Rocket Red™, GPX-14 Fire Orange™, GPL-15 Blaze Orange™, GPX-17 Saturn Yellow®, GPL-19 Horizon Blue™, GPL-21 Corona Magenta™, GPL-00 Clear, MP-CH5510 Chartreuse, MP-GR5511 Green, MP-OY5512 Orange-Yellow, MP-OG5513 Orange, MP-RD5515 Red, MP-MG5518 Magenta, MP-PR5547 Purple, MP-CE5606 Cerise, MP-PK5661 Pink, MP-BL6182 Blue, NX-13C Rocket Red™, NX-14C Fire Orange™, NX-15C Blaze Orange™, NX-17C Saturn Yellow®, NX-21C Corona Magenta™, T-11 Aurora Pink®, T-13 Rocket Red™, T-14 Fire Orange™, T-15 Blaze Orange™, T-16 Arc Yellow™, T-17N Saturn Yellow®, T-18N Signal Green™, T-19 Horizon Blue™, GT-11 Aurora Pink®, GT-13 Rocket Red™, GT-14N Fire Orange™, GT-15N Blaze Orange™, GT-17N Saturn Yellow®, GT-21 Corona Magenta™ VCL2014 Fire Orange™, VCL1700 Saturn Yellow®, VCL2018 Signal Green™, Z-11 Aurora Pink®, Z-12 Neon Red™, Z-13 Fire Orange™, Z-14 Fire Orange™, Z-15 Blaze Orange™, Z-17-N Saturn Yellow®, Z-18 Signal Green™, Z-21 Corona Magenta™, ZQ-11 Aurora Pink®, ZQ-12 Neon Red™, ZQ-13 Rocket Red™, ZQ-14 Fire Orange™, ZQ-15 Blaze Orange™, ZQ-17 Saturn Yellow®, ZQ-18 Signal Green™, ZQ-19 Horizon Blue™, ZQ-21 Corona Magenta™, supplied by DayGlo®, and BSR, BSTS, BMS, BFE, BGP, BSTW, BGP, BNF, BVC, BIB2, BWD, supplied by Brilliant®.

The electrophoretic medium of the present invention may further comprise, in addition to the first type of fluorescent particles, a second type of fluorescent particles. The second type of fluorescent particles may comprise a core and shell. The core may comprise a second type of fluorescent pigment. The shell may comprise a polymeric layer and a steric stabilizer. The polymeric layer of the shell of the second type of fluorescent particle may comprise a polymeric material, which may be formed on the surface of the core by polymerization of a third type of monomer or oligomer. The polymeric layer may also be formed from a reaction of a third type of macromonomer with the second type of fluorescent pigment, or from the adsorption or complexation of a third type of polymer onto the surface of the second type of fluorescent pigment. The steric stabilizer of the shell of the second type of fluorescent particle may be formed on the surface of the polymeric layer from a fourth type of monomer, or oligomer. The steric stabilizer may also be formed from a reaction of a fourth type of macromonomer with the polymeric layer, or from the adsorption or complexation of a fourth type of polymer onto the surface of the polymeric layer. The monomers, oligomer and macromonomer of the polymeric layer and the steric stabilizer may comprise acrylate, methacrylate, styrene, siloxane, ethylene, propylene, or a mixture thereof. The steric stabilizer of the second type of fluorescent particles enables the second type of fluorescent particles in the electrophoretic medium to be in a non-flocculated and non-aggregated state. The polymeric layer may comprise more than one polymers and may be formed by more than one monomers, oligomers or macromonomers. The steric stabilizer may also comprise more than one polymers and may be formed by more than one monomers, oligomers or macromonomers. The polymeric layer may be covalently bonded to the second type of fluorescent pigment or it may be adsorbed or complexed on the surface of the second type of fluorescent pigment. The steric stabilizer may be covalently bonded onto the polymeric layer. The steric stabilizer and the polymeric layer may comprise functional groups that enable charge generation or interaction with a charge control agent.

The second type of fluorescent particles has a second color, which may be different from the first color of the first type of fluorescent particles. The second color may be orange, red, magenta, yellow, cyan, blue, violet, green, black, white, or another color. The second type of fluorescent particle has an electric charge of a second polarity. The second charge polarity of the second type of fluorescent particles may be opposite to the first charge polarity of the first type of fluorescent particles. The charge of the second type of fluorescent particles may be the result of charge or chargeable functional groups of the second type of fluorescent pigment or the charge or chargeable functional groups of the polymeric layer or charge or chargeable functional groups of the steric stabilizer or a charge because of the interaction of the second type of fluorescent particles with a charge control agent, which is present in the electrophoretic medium. The first charge polarity may be positive or negative. The second type of fluorescent particles may comprise from 10 weight percent to 100 weight percent of the second type of fluorescent pigment by weight of the second type of fluorescent particle, or from 20 weight percent to 95 weight percent of the second type of fluorescent pigment by weight of the second type of fluorescent particle, or from 25 weight percent to 92 weight percent of the second type of fluorescent pigment by weight of the second type of fluorescent particle, or from 35 weight percent to 90 weight percent of the second type of fluorescent pigment by weight of the second type of fluorescent particle, or from 45 weight percent to 85 weight percent of the second type of fluorescent pigment by weight of the second type of fluorescent particle, or from 50 weight percent to 85 weight percent of the second type of fluorescent pigment by weight of the second type of fluorescent particle, or from 60 weight percent to 80 weight percent of the second type of fluorescent pigment by weight of the second type of fluorescent particle. The volume average diameter of the second type of fluorescent particles may be from 100 nm to 5 μm, or from 300 nm to 1.5 μm, or from 500 nm to 1 μm.

The electrophoretic medium of the present invention may further comprise, in addition to the first type of fluorescent particles, a third type of charged particles comprising of third type of organic pigment. The third type of charged particles has a third color and a second charge polarity. The third color may be different from the first color of the first type of fluorescent particles. The second charge polarity of the third type of charged particles may be opposite to the first charge polarity of the first type of fluorescent particles. The third type of charged particles may be untreated organic pigment particles. Alternatively, one or more polymers may be covalently bonded, adsorbed or complexed on the third type of organic pigment to form the third type of charged particles. The third color may be orange, red, magenta, yellow, cyan, blue, violet, green, black, or another color. The third type of organic pigment may be CI pigment PR 254, PR122, PR149, PG36, PG58, PG7, PY138, PY150, PY20 or the like, which are commonly used organic pigment materials described in the color index handbook “New Pigment Application Technology” (CMC Publishing Co, Ltd, 1986) and “Printing Ink Technology” (CMC Publishing Co, Ltd, 1984). Specific examples may include Clariant Hostaperm Red D3G 70-EDS, Hostaperm Pink E-EDS, PV fast red D3G, Hostaperm red D3G 70, BASF Irgazine red L 3630, Cinquasia Red L 4100 HD, Irgazin Red L 3660 HD and the like.

The third type of charged particles may comprise from 10 weight percent to 100 weight percent of the third type of organic pigment by weight of the third type of charged particle, or from 20 weight percent to 95 weight percent of the third type of organic pigment by weight of the third type of charged particle, or from 25 weight percent to 92 weight percent of the third type of organic pigment by weight of the third type of charged particle, or from 35 weight percent to 90 weight percent of the third type of organic pigment by weight of the third type of charged particle, or from 45 weight percent to 88 weight percent of the third type of organic pigment by weight of the third type of charged particle, or from 50 weight percent to 85 weight percent of the third type of organic pigment by weight of the third type of charged particle, or from 60 weight percent to 80 weight of the third type of organic pigment by weight of the third type of charged particle. The volume average diameter of the third type of charged particles may be from 100 nm to 5 μm, or from 300 nm to 1.5 μm, or from 500 nm to 1 μm.

The electrophoretic medium of the present invention may further comprise, in addition to the first type of fluorescent particles, a fourth type of charged particles comprising of a fourth type of inorganic pigment. The fourth type of charged particles has a fourth color and a second charge polarity. The fourth color may be different from the first color of the first type of fluorescent particles. The second charge polarity may be opposite to the first charge polarity of the first type of fluorescent particles. The fourth type of charged particles may be untreated. Alternatively, one or more polymers may be covalently bonded, adsorbed or complexed on the fourth type of inorganic pigment to form the fourth type of charged particles. The fourth color may be white, black, orange, red, magenta, yellow, cyan, blue, violet, green, or another color. The fourth type of inorganic pigment may be TiO₂, BaSO₄, ZnO, metal oxide, manganese ferrite black spinel, copper chromite black spinel, carbon black or zinc sulfide pigment particles.

The fourth type of charged particles may comprise from 10 weight percent to 100 weight percent of the first type of inorganic pigment by weight of the fourth type of charged particle, or from 20 weight percent to 95 weight percent of the first type of inorganic pigment by weight of the fourth type of charged particle, or from 25 weight percent to 92 weight percent of the first type of inorganic pigment by weight of the fourth type of charged particle, or from 35 weight percent to 90 weight percent of the first type of inorganic pigment by weight of the fourth type of charged particle, or from 45 weight percent to 88 weight percent of one or more pigments by weight of the fourth type of charged particle, or from 50 weight percent to 85 weight percent of the first type of inorganic pigment by weight of the fourth type of charged particle, or from 60 weight percent to 80 weight percent of the first type of inorganic pigment by weight of the fourth type of charged particle. The volume average diameter of the fourth type of charged particles may be from 100 nm to 5 μm, or from 300 nm to 1.5 μm, or from 500 nm to 1 μm.

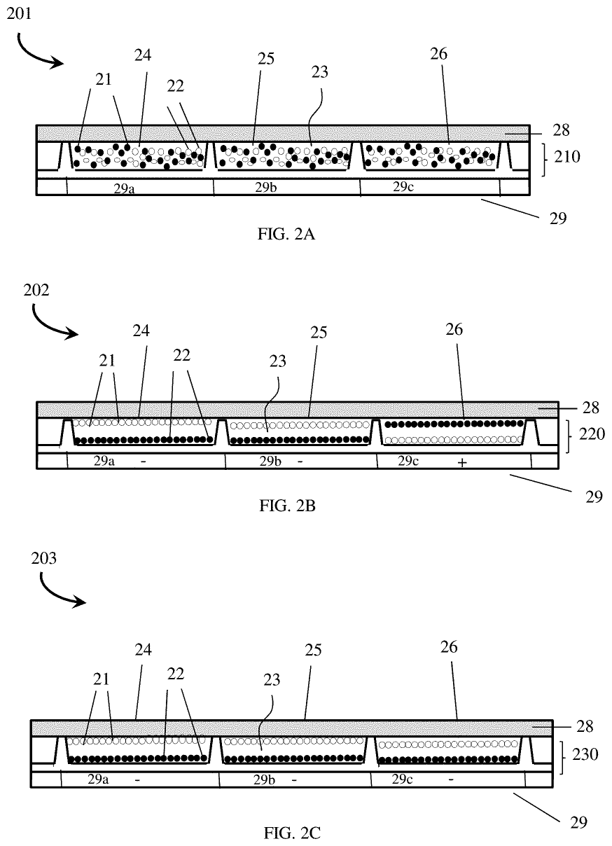

As mentioned above, the electrophoretic medium of the present invention may comprise a first type of fluorescent particles that have a first charge polarity and another type of charge particles that have an opposite charge polarity. For example, the electrophoretic medium may comprise a fourth type of charged particles that comprises a fourth type of inorganic pigment, wherein the fourth type of charged particle has a forth color that is different from the first color of the first type of fluorescent particles. The fourth type of charged particles has charge polarity that is opposite to the charge polarity of the first type of fluorescent particles. The fourth type of charged particles may or may not have a polymeric layer and/or a steric stabilizer on its surface. An example of electro-optic displays at three different optical states that comprise electrophoretic medium comprising a first type of fluorescence particles and a fourth type of charged particles is provided in FIGS. 2A-2C. In this example, the color of the fourth type of charged particles is white.

FIG. 2A illustrates an electro-optic device at optical state 201. This optical state is observed when no electric field is applied on electrodes 28 and 29 of the device. Specifically, the device comprises an electro-optic material layer 210 comprising electrophoretic medium encapsulated in microcells 24, 25 and 26. The electrophoretic medium comprises first type of fluorescent particles 22 and fourth type of charged particles 21 (white) in electrophoretic fluid 23. The electrophoretic medium is disposed between two electrodes 28 and 29. Electrode 28 is light-transmissive and electrode 29 comprises pixel electrodes 29a, 29b, and 29c. The two types of electrophoretic particles 21 and 22 have opposite electric charge polarities. First type of fluorescent particles 22 is positively charged and fourth type charged particles 21 are negatively charged. The two types of electrophoretic particles 21 and 22 are randomly distributed throughout the electrophoretic medium, because no electric field is applied to the electro-optic medium layer via electrodes 28 and 29.

FIG. 2B illustrates the same device at optical state 202. In this optical state, pixel electrodes 29a and 29b have negative voltage potential, whereas pixel electrode 29c has positive voltage potential. Because electrophoretic particles 22 are positively charged, they are driven towards pixel electrodes 29a and 29b (and away from away from the light-transmissive electrode 28). Oppositely charged electrophoretic particles 21 (white) move towards the light-transmissive electrode 28 at locations that correspond to pixel electrodes 29a and 29a (microcells 24 and 25). Thus, at these locations, the display appears white. On the contrary, negatively charged white electrophoretic particles 21 move towards pixel electrode 29c having positive voltage potential. Thus, at the location that corresponds to pixel electrode 29c (microcell 26), the display appears to have the first color (that is, the color of the first type of fluorescent particles), because the first type of fluorescent particles move towards light-transmissive electrode 28.

FIG. 2C shows the same device, but at optical state 202. In this optical state, all three pixel electrodes 29a, 29b, and 29c have negative voltage potential. Because electrophoretic particles 22 are positively charged, they are driven towards pixel electrodes 29a, 29b, and 29c (and away from the light-transmissive electrode 28). Oppositely charged electrophoretic particles 21 (white) move towards the light-transmissive electrode 28 at locations that correspond to pixel electrodes 29a, 29a, and 29c (microcells 24, 25, and 26). Thus, the display appears white in all three microcells 24, 25, and 26.

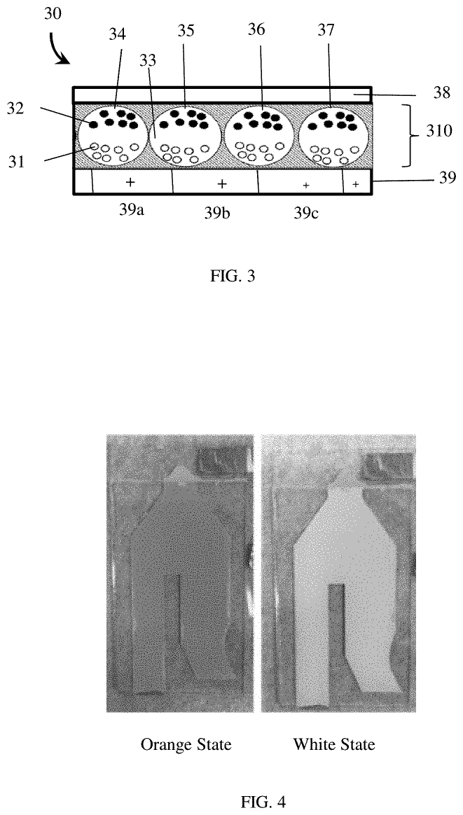

FIG. 3 shows an electro-optic device 30 comprising an electro-optic material layer 310 in an optical state. The electro-optic material layer 310 comprises electrophoretic medium encapsulated in microcapsules 34, 35, 36, and 37. Electrophoretic medium comprises first type of fluorescent particles 32 and fourth type of charged particles 31 in electrophoretic fluid 33. The electro-optic material layer 310 is disposed between two electrodes 38 and 39. Electrode 38 is light-transmissive and electrode 39 comprises pixel electrodes 39a, 39b, and 39c. The two types of electrophoretic particles 31 and 32 have opposite charge polarities. First type of fluorescent particles 32 is negatively charged and second type of charged particles 31 is positively charged. Electrode 38 and pixel electrodes 39a, 39b, and 39c apply an electric field on microcells 24, 25, and 26 that drives the negatively charged first type of fluorescent particles 32 towards the light-transmissive electrode 38. Negatively charged fourth type of charged particles 31 (white) are driven towards the second electrode and away from the light-transmissive electrode. Thus, the electro-optic display appears to have the color of the first fluorescent type of particles 32 on the viewing side of the display.

The first type of fluorescent particles of the present invention enable bright images, vibrant color of the corresponding electro-optic optical states. The shell of the first type of fluorescent particles contribute to the stability of the particle against their aggregation and stability of the optical states of the corresponding electrophoretic device. The following disclose provide a discussion on the formation and technical features of the polymeric layer and the steric stabilizer of the fluorescent particles.

The surface of the first type of fluorescent pigment may be pre-treated before the formation of the polymeric layer. The pigment surface pre-treatment may improve compatibility of the core first type of fluorescent pigment with the first type of monomer or oligomer. It may also form functional groups of the pigment surface that can react with the functional groups of the first type of monomer or oligomer, leading to a covalent bonding between the pre-treated surface and the polymeric layer. For example, the surface pre-treatment may be carried out with an organic silane having functional groups, such as acrylate, vinyl, —NH₂, —NCO, —OH or the like. These functional groups may undergo chemical reaction with the first type of monomer or oligomer. The polymeric layer may be an organic polymer, such as polyacrylate, polyurethane, polyurea, polyethylene, polyester, polysiloxane or the like. The pre-treatment may be performed using an inorganic or organic material. Inorganic materials may include silica, aluminum oxide, zinc oxide and the like or a combination thereof. Sodium silicate or tetraethoxysilane may be used as a common precursor for silica coating. Inorganic materials on the surface of the first type of fluorescent pigment may be porous to reduce the density of the first type of fluorescent particles. The same surface pre-treatment, as described above, can be applied to second type of fluorescent pigments that are used for the second type of fluorescent particles, the third type of charged particles, and the fourth type of pigment particles, if they are present in the electrophoretic medium. Surface treatment may be applied on the surface of the third and fourth types of pigment, even if the third and fourth types of charged particles (formed from the third and fourth types of pigment) do not comprise a polymeric layer and/or a steric stabilizer.

As described above, the first type of fluorescent particles (and the second type of fluorescent particles, if present in the electrophoretic medium), comprises a shell comprising a polymeric layer and a steric stabilizer. The polymeric layer of the shell may be formed from a polymer, such as polyacrylate, polyurethane, polyurea, polyethylene, polyester, polysiloxane or the like. For example, a polyacrylate polymeric layer may be formed from a monomer, such as styrene, methylstyrene, methyl acrylate, methyl methacrylate, n-butyl acrylate, n-butyl methacrylate, t-butyl acrylate, t-butyl methacrylate, vinyl pyridine, n-vinyl pyrrolidone, 2-hydoxyethyl acrylate, 2-hydroxyethyl methacrylate, dimethylaminoethyl methacrylate or the like. A polyurethane polymer layer may be formed from a monomer or oligomer, such as multifunctional isocyanate or thioisocyanate, primary alcohol or the like. A polyurea polymeric layer may be formed from a monomer or oligomer containing reactive groups, such as amine/isocyanate, amine/thioisocyanate or the like. A person skilled in the art would be able to select proper monomer or oligomer and its variations, based on the main idea of the present invention. The same polymeric layers may be present in the third and fourth charged particles, if they are present in the electrophoretic medium of the present invention.

The material of the polymeric layer may be either completely incompatible or relatively incompatible with the non-polar fluid of the electrophoretic medium in which the first type of fluorescent particles are dispersed. The term “relatively incompatible” as used herein, means that no more than about 5%, preferably no more than about 1%, of the material of the polymer layer is miscible with the non-polar fluid of the electrophoretic medium. The above is also true for the second, third, and fourth charged particles, if present in the electrophoretic medium, and if they comprise polymeric layer and/or steric stabilizer. In order to achieve this complete or relative incompatibility in the non-polar fluid, the polymeric layer may have polar functionality on its main chain or a side chain. Examples of such polar functionality may include —COOH, —OH, NH₂, R—O—R, R—NH—R and the like, wherein R is an alkyl or aryl group. Each of the side chains, in this case, preferably has less than 6 carbon atoms. In one embodiment, the main chain or the side chain may contain an aromatic moiety.

In addition, the first type of fluorescent pigment (core) and the polymeric layer should behave as one single unit. This may be achieved by cross-linking or an encapsulation technique, as described below.

The preparation of the first type of fluorescent particles of the present invention may involve a variety of techniques. For example, the first type of fluorescent particles may be formed by dispersion polymerization. During dispersion polymerization, a first type of monomer or oligomer may be polymerized around the core pigment particles in the presence of a steric stabilizer polymer, wherein the steric stabilizer is soluble in the reaction medium. The solvent selected as the reaction medium must be a good solvent for both the first monomer or oligomer and the steric stabilizer polymer, but a non-solvent for the polymeric layer being formed. For example, in an aliphatic hydrocarbon solvent such as Isopar G®, monomer methylmethacrylate is soluble; however, after polymerization, the resulting polymethylmethacrylate is not soluble.

The steric stabilizer of the shell of the first type of fluorescent particles (and the second type of fluorescent particles, if present) usually comprises a high molecular weight polymers, such as polyethylene, polypropylene, polyester, polysiloxane or a mixture thereof. The steric stabilizer facilitates and stabilizes the dispersion of the first type of fluorescent particles in the non-polar fluid of the electrophoretic medium. Furthermore, the steric stabilizer may optionally have functional groups that would enable charge generation or interaction with a charge control agent that is present in the electrophoretic medium. The above feature of the steric stabilizer also apply in the cases where a steric stabilizer is present in the third and fourth types of charged particles of the electrophoretic medium, if such types of charged particles are present in the electrophoretic medium.

The steric stabilizer polymer may be a polymer or a macromonomer that adsorbs, complexes with, or is chemically bonded to the surface of the polymeric layer. The nature of the macromonomer as a steric stabilizer, determines the particle size and colloidal stability of the system.

The macromonomer may be an acrylate-terminated or vinyl-terminated macromolecule, which are suitable because the acrylate or vinyl group can co-polymerize with the monomer in the reaction medium.

The macromonomer preferably has a long tail, R, which may stabilize the first type of fluorescent particles in a hydrocarbon solvent.

One type of macromonomers is acrylate terminated polysiloxane (Gelest, MCR-M11, MCR-M17, MCR-M22), as shown below:

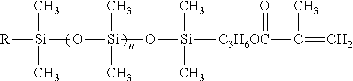

Another type of macromonomers that is suitable for the process is PE-PEO macromonomers, as shown below:

RₘO—[—CH₂CH₂O—]ₙ—CH₂-phenyl-CH═CH₂

or

RₘO—[—CH₂CH₂O—]ₙ—C(═O)—C(CH₃)═CH₂

The substituent R may be a polyethylene chain, n is 1-60 and m is 1-500. The synthesis of these compounds may be found in Dongri Chao et al., Polymer Journal, Vol. 23, no.9, 1045 (1991) and Koichi Ito et al, Macromolecules, 1991, 24, 2348.

Another type of suitable macromonomers is PE macromonomers, as shown below:

CH₃—[—CH₂—]ₙ—CH₂O—C(═P)—C(CH₃)═CH₂

The n, in this case, is 30-100. The synthesis of this type of macromonomers may be found in Seigou Kawaguchi et al, Designed Monomers and Polymers, 2000, 3, 263.

To incorporate functional groups for charge generation, a co-monomer may be added in the reaction medium. The co-monomer may either directly charge the first type of fluorescent particles or interact with a charge control agent in the electrophoretic fluid to bring a desired charge polarity and charge density to the first type of fluorescent particles. Suitable co-monomers may include vinylbenzylaminoethylamino-propyl-trimethoxysilane, methacryloxypropyltrimethoxysilane, acrylic acid, methacrylic acid, vinyl phosphoric acid, 2-acrylamino-2-methylpropane sulfonic acid, 2-(dimethylamino)ethyl methacrylate, N-[3-(dimethylamino)propyl]methacrylamide and the like.

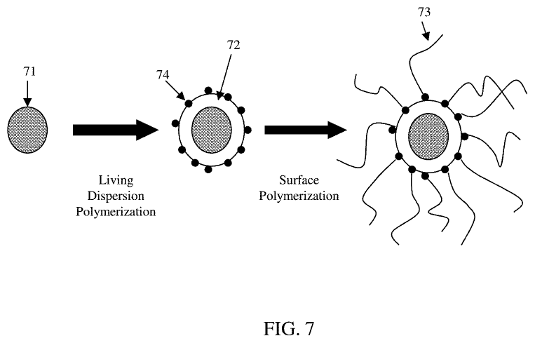

Alternatively, the first type of fluorescent particles may be prepared by living radical dispersion polymerization as shown in FIG. 7. The living radical dispersion polymerization technique is similar to the dispersion polymerization described above by starting the process with fluorescent particles 71 and a monomer or oligomer dispersed in a reaction medium. The monomers used in the process to form the polymeric layer 72 may include styrene, methylstyrene, methyl acrylate, methyl methacrylate, n-butyl acrylate, n-butyl methacrylate, t-butyl acrylate, t-butyl methacrylate, vinyl pyridine, n-vinyl pyrrolidone, 2-hydoxyethyl acrylate, 2-hydroxyethyl methacrylate, dimethylaminoethyl methacrylate and the like. However, in this alternative process, multiple living ends 74 are formed on the surface of the polymeric layer. The living ends may be created by adding an agent such as TEMPO (2,2,6,6-tetramethyl-1-piperidinyloxy), a RAFT (reversible addition-fragmentation chain transfer) reagent or the like, in the reaction medium, for the living radical polymerization.

In a further step, an additional monomer is added to the reaction medium to cause the living ends 74 to react with the second monomer to form the steric stabilizers 73. The additional monomer may be lauryl acrylate, lauryl methacrylate, 2-ethylhexyl acrylate, 2-ethylhexyl methacrylate, hexyl acrylate, hexyl methacrylate, n-octyl acrylate, n-octyl methacrylate, n-octadecyl acrylate, n-octadecyl methacrylate or the like. The steric stabilizers should be compatible with the non-polar fluid of the electrophoretic medium, in which the first type of fluorescent particles are dispersed to facilitate dispersion of the first type of fluorescent particles. The steric stabilizers may also be prepared through living radical polymerization. A co-monomer may also be added to generate charge in the steric stabilizer. Suitable co-monomers may include vinylbenzylaminoethylaminopropyl-trimethoxysilane, methacryloxypropyltrimethoxysilane, acrylic acid, methacrylic acid, vinyl phosphoric acid and the like.

Further alternatively, the first type of fluorescent particles may be formed by coating the first type of fluorescent pigment (core) with polyurethane and/or polyurea. Polyurethane and polyurea usually are not compatible to a non-polar hydrocarbon solvent and their hardness and elastic property can be tuned through the monomer composition.

In one example of the present invention, the polymeric layer of the first type of fluorescent particles may be a polyurethane or polyurea and the steric stabilizers may comprise non-polar long chain hydrocarbon molecules.

The synthesis method for the formation of a polyurethane (or polyurea) polymeric layer of the first type of fluorescent particles may be similar to emulsion or dispersion polymerization inside micelles, except that polycondensation occurs. In this case, monomer or oligomers that form polyurethane (or polyurea) are used. The reaction mixture towards the formation of polyurethane (or polyurea) polymeric layer may comprise an oil-in-oil emulsion, which contains two incompatible solvents, one of which is a non-polar solvent and the other is a polar organic solvent. The reaction may also be referred to as non-aqueous emulsion polycondensation, in which the non-polar solvent is the continuous phase and the polar solvent is the non-continuous phase. The first monomer and the first type of fluorescent particles exist in the non-continuous phase. Suitable non-polar solvents may include the solvents of the Isopar® series, cyclohexane, tetradecane, hexane or the like. The polar solvents may include acetonitrile, DMF and the like.

An emulsifier or dispersant is critical for this biphasic reaction mixture. The molecular structure of the emulsifier or dispersant may contain one part that is soluble in the non-polar solvent, and another part that is anchored to the polar phase. This will stabilize the micelles/droplets containing the monomer and the first type of fluorescent particles and serving as a micro-reactor for the particle formation through polycondensation. Suitable emulsifiers or dispersants may include di-block co-polymers, such as poly (isoprene)-b-poly(methyl methacrylate), polystyrene-b-poly(ethene-alt-propene) (Kraton) or the like.

Also, a co-emulsifier may be added to form a chemical bonding on the particles. For example, amine terminated hydrocarbon molecules can react with the particles during polycondensation and bond to surface as robust steric stabilizers. Suitable co-emulsifiers may include surfonamine (B-60, B-100 or B-200) as shown below:

CH₃—[—OCH₂CH₂—]ₓ—[—OCH₂CH(CH₃)—]_{y}—NH₂

wherein x is 5-40 and y is 1-40.

An alternative approach is to continue growing polyacrylate steric stabilizers after the polycondensation reaction in the microreactor is completed. In this case, the polymeric layer is formed from polyurethane, while the steric stabilizers may comprise polyacrylate chains. After the emulsifier or dispersant, which is used in the process, is washed away from the particle surface, the resulting first type of fluorescent particles with polyacrylate steric stabilizer are stable when they are dispersed in the non-polar fluid of the electrophoretic medium. Some materials that can initiate acrylate polymerization include isocyanatoethyl acrylate, isocyanatostyrene or the like.

Monomers that form the steric stabilizer may include a mixture of hydroxyethyl methacrylate and other acrylate that are compatible with the non-polar solvent. Examples of such monomers include lauryl acrylate, lauryl methacrylate, 2-ethylhexyl acrylate, 2-ethylhexyl methacrylate, hexyl acrylate, hexyl methacrylate, n-octyl acrylate, n-octyl methacrylate, n-octadecyl acrylate, n-octadecyl methacrylate or the like.

In any of the processes described above, the quantities of the reagents used (e.g., the first type of fluorescent pigment, the material for forming the polymeric layer, and the material for forming the steric stabilizers) may be adjusted and controlled to achieve the desired shell of the first type of fluorescent particles.

Another aspect of the present invention is directed to a display fluid comprising the first type of fluorescent particles of the present invention in the non-polar fluid. The non-polar fluid may be a solvent having a low dielectric constant (preferably about 2 to 3), a high volume resistivity (preferably about 10¹⁵ ohm-cm or higher), and a low water solubility (preferably less than 10 parts per million). Suitable solvents may include, but are not limited to hydrocarbons, such as dodecane, tetradecane, the aliphatic hydrocarbons in the Isopar® series (Exxon, Houston, Tex.) and the like. The non-polar fluid can also be a mixture of a hydrocarbon and a halogenated carbon or silicone oil base material.

The present invention is applicable to a one-particle, two-particle or multiple particle electrophoretic media. In a multiple particle system, there may be more than two types of particles. Each type of particles may have a color that is different from the colors of other types.

In the case of a one-particle system, the present invention may be directed to an electrophoretic medium comprising only first type of fluorescent particles prepared according to the present invention that are dispersed in a dyed non-polar fluid. The first type of fluorescent particles and the non-polar fluid have contrasting colors.

Alternatively, the present invention may be directed to a display fluid comprising two types of particles dispersed in a clear non-polar fluid. At least one of the two types of the particles is prepared according to the present invention. The two types of particles carry opposite charge polarities and have contrasting colors. Relevant examples include the electro-optic devices illustrated in FIGS. 2A, 2B, 2C, and 3.

The first type of fluorescent particles prepared according to the present invention, when dispersed in a non-polar fluid, has many advantages. For example, the density of the first type of fluorescent particles may be substantially matched to the non-polar fluid. This improves the stability performance of the device. The difference between the density of the first type of fluorescent particles and the density of the non-polar fluid is preferably less than 2 g/cm³, more preferably less than 1.5 g/cm³ and most preferably less than 1 g/cm³.

In a two-particle system, if only one type of the particles is prepared according to the present invention, the other type of particles may be prepared by any other methods. For example, the particles may be polymer encapsulated pigment particles. Microencapsulation of the pigment particles may be accomplished chemically or physically. Typical microencapsulation processes include interfacial polymerization/crosslinking, in-situ polymerization/crosslinking, phase separation, simple or complex coacervation, electrostatic coating, spray drying, fluidized bed coating and solvent evaporation, etc.

The first type of fluorescent particles may exhibit a native charge. It may also be charged explicitly using a charge control agent. It may also acquire a charge when it is suspended in a non-polar fluid. Suitable charge control agents are well known in the art. They may be polymeric or non-polymeric in nature. They may also be ionic or non-ionic. Non-limiting examples of charge control agents include surfactants, such as sodium dodecylbenzenesulfonate, metal soap, polybutene succinimide, maleic anhydride copolymers, vinylpyridine copolymers, vinylpyrrolidone copolymer, (meth)acrylic acid copolymers or N,N-dimethylaminoethyl (meth)acrylate copolymers), Alcolec LV30 (soy lecithin), Petrostep B100 (petroleum sulfonate) or B70 (barium sulfonate), Solsperse 17000 (active polymeric dispersant), Solsperse 9000 (active polymeric dispersant), OLOA 11000 (succinimide ashless dispersant), OLOA 1200 (polyisobutylene succinimides), Unithox 750 (ethoxylates), Petronate L (sodium sulfonate), DisperBYK 101, 2095, 185, 116, 9077 & 220 and ANTI-TERRA series.

### EXAMPLES

### Example 1

### Preparation of First Type of Fluorescent Particles

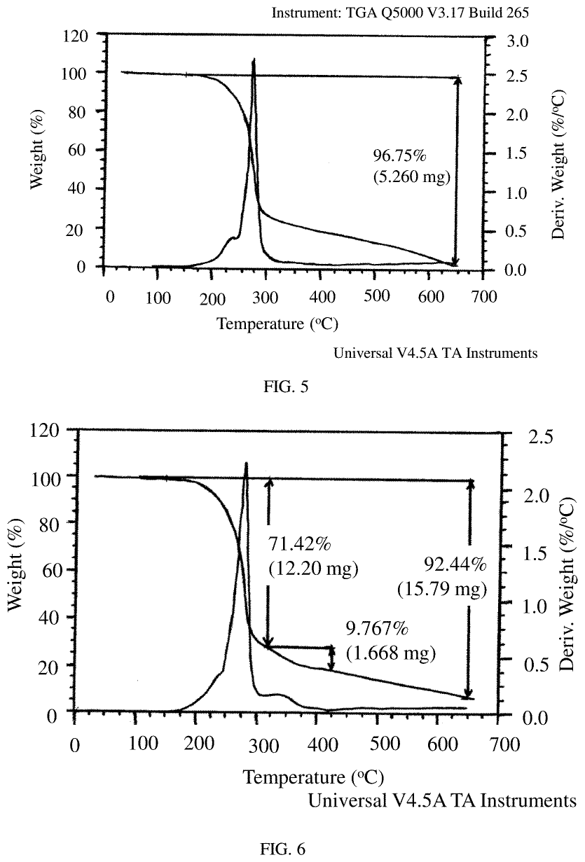

Fluorescent pigment Blaze Orange™ AX-15-N (supplied by DayGlo; 2.5 g), styrene (8 g) and toluene (2 g) were added into a 20 ml vial and sonicated for 2 hours. Into a 250 mL reactor, the above mixture, MCR-M22 (monomethacryloxypropyl terminated polydimethylsiloxane supplied by Gelest; 5.7 g) and DMS-T01 (trimethylsiloxy terminated polydimethylsiloxane supplied by Gelest; 30 g) were added. The reactor was heated to 70° C. with magnetic stirring and purged with nitrogen for 20 minutes, followed by the addition of lauroyl peroxide (0.07 g). After 19 hours, the mixture was centrifuged at 5000 rpm for 15 minutes. The solids produced were redispersed in hexane and centrifuged. This cycle was repeated twice and the solids were dried at room temperature under vacuum to produce the final particles. The polymer content of the first type of fluorescent particles produced by the process was determined via TGA (thermal gravimetric analysis). The graph of percent weight loss from the first type of fluorescent particle sample versus temperature is provided in FIG. 6. The weight loss of the starting fluorescent pigment was also determined via TGA analysis. The corresponding percent weight loss of the starting pigment versus temperature is provided in FIG. 5. The TGA determination shows that the process of Example 1 successfully treated the first type of fluorescent particles with polymer. Furthermore, the TGA graph of the first type of fluorescent particles has an additional weight loss step from 300° C. to 400° C., which shows that the process created a new species. The TGA data of FIG. 6 show that the polymer content of the first type of particles is approximately 97 weight percent by weight of the fluorescent particle.

### Example 2

### Preparation of Electrophoretic Medium Comprising First Type of Fluorescent Particles from Example 1

An electrophoretic medium composition was prepared using the first type of fluorescent particles from Example 1, oppositely charged white TiO₂ particles, Isopar E (hydrocarbon solvent) and charge control agent (Solsperse 19000). The electrophoretic medium composition was include into a test cell disposed in between two electrodes and the cell was driven to the white and orange state by the application of an electric field (+15 V and −15 V for 2 seconds). The color of the two state was measured spectrometrically. The results are provided in Table 1 and in FIG. 4.

TABLE 1
Color Data of White and Orange States from Example 2.
Color Measurements in Test Cell

| | | |
|---|---|---|
| White State | L* | 65.9 |
| | a* | 1.1 |
| | b* | 1.6 |
| Orange State | L* | 54.6 |
| | a* | 45.7 |
| | b* | 61.7 |

The first type of fluorescent particles was evaluated for dispersion stability by observing the dispersion of the particles in Isopar E and comparing them with the corresponding dispersion using the corresponding untreated pigment. The two dispersions were observed for potential sedimentation. The pigment particles of the dispersion of the untreated first type of fluorescent pigment settled immediately after the preparation of the dispersion. On the contrary, the dispersion of the first type of fluorescent particles was stable for at least a few days. Furthermore, the two dispersions were also observed for agglomeration under optical microscopy. It was observed that the dispersion made from the untreated fluorescent pigment shows fast agglomeration, as opposed to the dispersion of the first type of fluorescent particles, which showed only slight agglomeration.

While the present invention has been described with reference to the specific embodiments thereof, it should be understood by those skilled in the art that various changes may be made and equivalents may be substituted without departing from the scope of the invention.

We claim:

1. An electrophoretic medium comprising:
a first type of fluorescent particles dispersed in a non-polar fluid, the first type of fluorescent particles comprising a core and a shell, the core comprising a first type of fluorescent pigment, and the shell comprising a polymeric layer and a steric stabilizer, the first type of fluorescent particles having a first color.

2. The electrophoretic medium of claim 1, wherein the first type of fluorescent pigment comprises a fluorescent dye in a polymer matrix.

3. The electrophoretic medium of claim 1, wherein the first type of fluorescent particles are charged, having a first charge polarity.

4. The electrophoretic medium of claim 3, further comprising a second type of fluorescent particles comprising a core and a shell, the core comprising a second type of fluorescent pigment, and the shell comprising a polymeric layer and a steric stabilizer, the second type of fluorescent particles having a second color, the second color being different from the first color, and the second charge polarity being opposite from the first charge polarity.

5. The electrophoretic medium of claim 3, further comprising a third type of charged particles comprising a third type of organic pigment, wherein the third type of organic pigment has a third color and a second charge polarity, the third color being different from the first and the second colors, and the second charge polarity being different from the first charge polarity.

6. The electrophoretic medium of claim 3, further comprising a fourth type of charged particles comprising a fourth type of inorganic pigment, wherein the fourth type of inorganic pigment has a fourth color and a second charge polarity, the fourth color being different from the first, second and third colors, and the second charge polarity being different from the first charge polarity.

7. The electrophoretic medium of claim 1, wherein the core of the first type of fluorescent particles further comprises a fifth type of pigment selected from the group consisting of a fluorescent pigment, an organic pigment, an inorganic pigment, and a mixture thereof.

8. The electrophoretic medium of claim 1, wherein the polymeric layer of the shell is adsorbed, complexed, or covalently bonded onto the surface of the first type of fluorescent particles.

9. The electrophoretic medium of claim 1, wherein the steric stabilizer of the shell is adsorbed, complexed, or covalently bonded onto the polymeric layer of the shell.

10. The electrophoretic medium of claim 1, wherein the non-polar fluid is colorless.

11. The electrophoretic medium of claim 1, wherein the non-polar fluid is colored with a dye.

12. The electrophoretic medium of claim 1, wherein the first type of fluorescent particles comprises from 10 to 90 weight percent of first type of fluorescent pigment by weight of the first type of fluorescent particles.

13. The electrophoretic medium of claim 1, wherein the polymeric layer of the shell of the first type of fluorescent particles is formed from polymerization of a first monomer or oligomer, the first monomer or oligomer being selected from the group consisting of acrylate, methacrylate, styrene, methylstyrene, siloxane, ethylene, propylene, and mixtures thereof.

14. The electrophoretic medium of claim 1, wherein the steric stabilizer of the shell of the first type of fluorescent particles is formed from polymerization of a second monomer or oligomer, the second monomer or oligomer being selected from the group consisting of acrylate, methacrylate, styrene, methylstyrene, siloxane, ethylene, propylene, and mixtures thereof.

15. The electrophoretic medium of claim 1, further comprising a charge control agent.

16. An electro-optic device comprising a first light-transmissive electrode layer, an electrophoretic medium layer, and a second electrode layer, the electrophoretic medium layer being located between the first light-transmissive layer and the second electrode layer, wherein the electrophoretic medium layer comprises the electrophoretic medium of claim 1.

17. A method of manufacturing an electrophoretic medium comprising the steps:
(1) providing a dispersion of a first type of fluorescent pigment in a carrier;
(2) forming a first type of fluorescent particles by the addition of a first type of monomer or oligomer and a second type of monomer or oligomer into the dispersion of the first type of fluorescent pigment in the carrier, and by polymerization of the first monomer or oligomer and the second monomer or oligomer under agitation;
the first type of fluorescent particles comprising a core and a shell, the core comprising the first type of fluorescent pigment, and the shell comprising a polymeric layer formed by the polymerization of the first monomer or oligomer, and a steric stabilizer formed by the polymerization of the second polymer or oligomer.

18. The method of manufacturing an electrophoretic medium according to claim 17, wherein, after the step of forming the first type of fluorescent particles, the method further comprising the steps:
(3) isolating the first type of fluorescent particles; and
(4) redispersing the isolated first type of fluorescent particles into a non-polar fluid.

19. The method of manufacturing an electrophoretic medium according to claim 17, wherein the first type of fluorescent pigment comprises a fluorescent dye in a polymer matrix.

20. The method of manufacturing an electrophoretic medium according to claim 17, wherein the polymerization of the first monomer or oligomer is a living polymerization.
